(19) United States
(12) Patent Application Publication
(10) Pub. No.: US 2002/0154250 A1
(43) Pub. Date: Oct. 24, 2002

(54) Touch panel with light guide and manufacturing method thereof

(76) Inventor: Gil-Bum An, Anyang-si (KR)

Correspondence Address: LAW OFFICES OF BRIAN S STEINBERGER, 101 BREVARD AVENUE, COCOA, FL, 32922, US

(21) Appl. No.: 09/990,624

(22) Filed: Nov. 16, 2001

(30) Foreign Application Priority Data
Apr. 18, 2001 (KR) 2001-20640

(51) Int. Cl. G02F 1/1335

(52) U.S. Cl. 349/12

(57) ABSTRACT

A light guide of a frontlight liquid crystal display (LCD) is integrally formed in a touch panel, and methods of fabricating the panel with the guide and laminating the panel with the guide. A touch panel conductive film is coated on a guide surface; and spacers are placed on the film, and a sheet is bonded to the guide so that another film faces the spacers. The guide may be laminated on and bonded to a panel lower sheet; and a substrate may be formed by coating one film and then placing spacers on the other film, and an another substrate having the other film and the sheet may be bonded on spacers of the substrate so that the films faces each other. A capacitive touch panel film may be coated and formed directly on the guide surface; and a protective film may be laminated on this film. Methods include whether a film base is laminated or a film is coated on the guide surface on the basis of the panel lower elements; pre-processing the panel and the guide such that the guide becomes one element of the panel by laminating or coating the film base or the film on the guide; and post-processing the panel and the guide such that after completion of the panel elements, the other film bases or electrode films corresponding to other elements are laminated on the guide.

This invention claims the benefit of priority to Korean Patent Application 2001-20640 filed Apr. 18, 2001. The present invention relates to a touch panel with a light guide or a light guide with a touch panel wherein the light guide of a front light liquid crystal display (LCD) is integrally formed in the touch panel, and to methods of fabricating the touch panel with the light guide and of laminating the touch panel with the light guide onto the frontlight LCD.

### BACKGROUND AND PRIOR ART

A light guide has been known as a planar dimming system used in a backlight of the LCD. The planar dimming system is constructed in such a manner that a light source such as a cold cathode fluorescent lamp is arranged around the light guide, which has a flat upper face and a plurality of polyhedral prisms, and along a periphery of one side of the light guide made of transparent acryl resin, that a reflector is arranged on a lower face of the light guide in parallel thereto, and that a liquid crystal display (LCD) is arranged on an upper face of the light guide with a predetermined gap in parallel thereto.

The planar dimming system is a surface light source for use in a backlight LCD, and it is also considered as a sidelight type in which a transparent flat panel is used as a light guide. Light of the light source emitted from one of lateral sides of the light guide, which is comprised of the transparent parallel flat panel or a wedge-shaped flat panel, is propagated uniformly to the entire region of the light guide by using a total reflection characteristic of a floodlight flat panel, and a portion of the propagated light is emitted from a surface of the light guide in the form of diffuse light by converting it into diffuse reflected light having a reflection angle smaller than a critical angle through a light diffusing reflector disposed on a rear face of the light guide. In a case where external light such as solar light, room light or the like is used as an auxiliary light source, a surface light source for use in the backlight LCD in which a portion for receiving the external light is installed has also been known. In this case, a shape of the portion for receiving the external light is arcuate in section in order to construct one cylindrical lens.

As compared with the light guide used in the backlight type, the light guide employed in a frontlight LCD has advantages in that it does not need a diffuser, a reflector, a wedge-shaped section, etc. and it can be simply made of resin film. Therefore, it has been widely used for a mobile equipment (PDA etc.).

FIG. 1 shows a schematic sectional structure of a frontlight LCD panel 10. According to the structure, a frontlight lamp 21 is formed in a light guide 20, a liquid crystal display (LCD) 30 is comprised of an upper glass sheet 40 and a lower glass sheet 50, and the light guide 20 is placed on the upper glass sheet 40 of the LCD 30 rather than on a rear face of the LCD 30.

FIG. 2 shows a schematic sectional structure of a liquid crystal display (LCD) panel 10 wherein a touch panel 60 serving as an input device is added to or integrated into a light guide 20 of a frontlight LCD. Although the touch panel 60 is one of input devices, it has features that its input operation is simple, there is little possibility of wrong operation, and it is possible to input characters with hands, as compared with the other input devices such as a mouse or a keyboard. Thus, it has been well known in a various shape and manner. There is a resistive touch panel that is constructed by bonding together two sheets having different resistance components arranged such that the two sheets can be isolated by spacers and contacted with each other by pressing action. Further, there are a capacitive touch panel, an ultrasonic wave touch panel, an optical (infrared) sensor touch panel, an electromagnetic induction touch panel, etc.

FIG. 3 is shows the basic constitution of the resistive touch panel 60. Conductive electrode films 63, 64 are coated on an upper substrate 61 and a lower substrate 62, respectively, and spacers 66 are formed on any one of the conductive electrode films. Further, the conductive films are bonded by an adhesive 65 so that the conductive films 63, 64 thereof can face each other. The upper substrate 61 comes into contact with the lower substrate 62 by pressure applied upon depression thereon for input. The upper substrate 61 is made of a flexible PET film or a thin glass sheet. Since the thin glass sheet has an optical isotropy, it is used for reducing surface reflection of the substrate by attaching the polarizer onto the substrate. However, the touch panel with a plastic film having optical isotropy attached thereto is recently available.

The detection of an input position is made by a structure configured such that spacers 66 are interposed between the upper and lower substrates 61, 62 and input signals are extracted through a terminal. As for its operation, when the upper substrate 61 comes into contact with the lower substrate 62 on an input point and a voltage is applied between the electrodes of the lower substrate 62, a potential gradient is produced on resistive surfaces between both electrodes. The resulting voltage is read through the electrodes of the upper substrate 61 and an X-axis input position is then calculated by a controller. Subsequently, a voltage is applied between the electrodes of the upper substrate 61 and the resulting voltage is read through the electrodes of the lower substrate 62 so as to calculate a Y-axis input position. Thus, the input point is shown on the display. By repeating the above procedures at a high rate, input positions are continuously shown on the display so that characters or lines are drawn.

All the touch panels including the resistive touch panel should satisfy required characteristics of the touch panel requested by a user in accordance with multiple purposes of the products for installing the touch panel therein, regardless of the kinds and methods thereof. In order to meet these characteristics of the touch panel, the structure of the touch panel may be accepted to a certain extent through a partial structural modification of the touch panel. However, it is difficult to accept all the characteristics. In addition, there is a limit on acceptance of the required characteristics by means of the only resistive touch panel 60. Therefore, there is a need to select an optimal one of the structures or detecting methods of the touch panel suitable for the various required characteristics.

In view of the required characteristics, the resistive touch panel is suitable for daily life of the general public where the price, productivity, character writing and the like thereof have priority over all other things. An elastic wave type touch panel is suitable for use in industrial equipments where the durability, optical property, insulating property, and the like thereof are of importance. Therefore, the characteristics of the touch panel depend entirely on selection of the touch panel by the user.

Although there are many cases, similar to FIG. 2, where an LCD is used for a display in which the touch panel 60 is installed, the LCDs are classified according to usage of products because there are many types of LCDs. In order to classify the LCDs suitable for installing the touch panel therein, various classifying manners are taken into consideration.

For example, it is possible to classify the LCDs into monochrome and color types, backlight (rearlight type using the light guide) and frontlight types, or STN and TFT types in view of their structures. In particular, due to the improvements of high resolution of the TFT and color yield of the frontlight LCD, there is a great demand for the touch panel to be mounted on the LCD.

The structure of FIG. 2 is a laminate structure of the LCD panel 10 wherein the touch panel 60 is applied to the frontlight LCD 30. A typical LCD panel to which the touch panel 60 is laminated as an input device is constructed in such a manner that the light guide 20 is placed below the lower substrate 63 of the touch panel 60 comprising the upper and lower substrates 61, 63; the upper glass sheet 40 of the LCD is placed below the light guide 20; and the lower glass sheet 50 is laminated below the upper glass sheet 40 with a liquid crystal injected between the upper and lower glass sheets.

In a case where the touch panel 60 serving as the input device is added to the frontlight LCD panel 10, a fine air gap may be produced according to the process yield during its lamination process. As a typical air gap, there are an air gap L1 formed between a lower surface of the lower substrate 63 of the touch panel 60 and an upper surface of the light guide 20 and an air gap L2 formed between a lower surface of the light guide 20 and an upper surface of the upper glass sheet 40 of the LCD.

When the frontlight LCD 30 is used together with the light guide 20, the light guide converts visual light into linearly polarized light at both faces of the LCD panel. To this end, the surfaces of the light guide 20 may be subject to a special process, but they are generally made of ordinary resin films.

FIG. 4 shows paths of light through the laminate structure of the display panel wherein the touch panel 60 is added to the light guide 20 of the frontlight LCD panel 10. The paths of light are denoted as a, b, c, d and e, respectively, wherein a is an light-reflecting path on the upper substrate 61 of the touch panel 60, b and c are light-reflecting paths generated within the air gap L1 of laminating surfaces of the touch panel 60 and the light guide 20, and d and e are light-reflecting paths generated within the air gap L2 of laminating surfaces of the light guide 20 and the LCD upper glass sheet 40.

Here, since the light reflection within the air gaps L1, L2 is produced larger than the other layers, light transmissivity is reduced as much as that. Thus, it is a cause of deterioration of image quality.

Reduction of the light transmissivity due to the air gaps L1, L2 is a structural problem that may be mainly produced during the lamination process. There is also another problem in that required characteristics of the touch panel mentioned above cannot be satisfied.

That is, most of the touch panels are heavy since they are made of glass and plastic materials, and they are also designed to have a predetermined thickness for making preparations for film damage thereof. Further, the light guide should be laminated onto the touch panel. Thus, as for the assembled module required for mobility thereof, the problem that it has too much weight and thickness is produced. Accordingly, there are problems in view of thinness, lightness and miniaturization thereof.

In addition, in a case where the touch panel is simply added to the light guide of the frontlight LCD panel, the distance between the surface of the touch panel to be touched and a layer for forming a picture of the LCD is widened due to the thickness of the touch panel. Therefore, there is an operating problem in that a user should press down on the picture strongly.

### SUMMARY OF THE INVENTION

An object of the present invention is to provide a touch panel with a light guide integrally formed therein wherein the light guide needed in a frontlight LCD is integrally provided in the touch panel, or a light guide with a touch panel integrally formed therein wherein the touch panel is integrated into the light guide.

Another object of the present invention is to provide methods of manufacturing a touch panel with a light guide integrally formed therein or a light guide with a touch panel integrally formed therein and of laminating the light guide onto a LCD.

A further object of the present invention is to improve light transmissivity by reducing air gaps produced in a laminate structure of a LCD panel wherein a touch panel is added to a frontlight LCD when manufacturing the laminate structure.

A still further object of the present invention is to provide a thin, lightweight, compact laminate structure of a LCD panel wherein a touch panel is added to a frontlight LCD.

According to an aspect of the present invention for achieving the above objects, there is provided a touch panel with a light guide integrally formed therein, which is configured by sequentially laminating a frontlight LCD having an upper glass sheet, liquid crystals and a lower glass sheet; a light guide bonded to the upper glass sheet of the frontlight LCD and having a frontlight lamp; and a touch panel having an upper sheet, spacers and conductive electrode films between the upper sheet and the light guide in this order with respect to the light guide. One of the conductive electrode films of the touch panel is coated on a surface of the light guide; and the spacers are placed on the one of the conductive electrode films coated on the light guide, and the upper sheet is bonded to the light guide so that the other of the conductive electrode films of the touch panel faces the spacers and the one of the conductive electrode films.

According to another aspect of the present invention, there is provided a touch panel with a light guide integrally formed therein, which is configured by sequentially laminating a frontlight LCD having an upper glass sheet, liquid crystals and a lower glass sheet; a light guide bonded to the upper glass sheet of the frontlight LCD and having a frontlight lamp; and a touch panel having an upper sheet, a lower sheet, spacers and conductive electrode films between the upper sheet and the lower sheet in this order with respect to the light guide. The light guide is laminated on and bonded to the bottom of the lower sheet of the touch panel; and a lower substrate is formed by coating one of the conductive electrode films on the lower sheet and then placing the spacers on the conductive electrode film, and an upper substrate having the other of the conductive electrode films and the upper sheet is bonded on the spacers of the lower substrate so that the upper and lower conductive electrode films face each other.

According to a further aspect of the present invention, there is provided a touch panel with a light guide integrally formed therein, which is configured by sequentially laminating a frontlight LCD having an upper glass sheet, liquid crystals and a lower glass sheet; a light guide bonded to the upper glass sheet of the frontlight LCD and having a frontlight lamp; and a capacitive touch panel having a conductive electrode film and a protecting film for protecting said conductive electrode film in this order with respect to the light guide. The conductive electrode film of the capacitive touch panel is coated and formed directly on a surface of the light guide; and the protective film is laminated on the conductive electrode film.

According to a further aspect of the present invention, there is provided a method for laminating a touch panel with a light guide integrally formed therein, comprising the steps of selecting whether a film base is laminated or a conductive electrode film is coated on a surface of the light guide on the basis of lower elements of the touch panel; pre-processing the touch panel and the light guide in such a manner that the light guide becomes one of the lower elements of the touch panel by laminating or coating the film base or the conductive electrode film on the light guide in accordance with the film base or the conductive electrode film selected in the above step; and post-processing the touch panel and the light guide in such a manner that after completion of the lower elements of the touch panel by incorporating the light guide into the lower elements of the touch panel through the pre-processing step, the other film bases or conductive electrode films corresponding to upper elements are laminated on the light guide.

According to a further aspect of the present invention, there is provided a method for laminating a touch panel with a light guide integrally formed therein by laminating the light guide on an upper glass sheet of a frontlight LCD and then laminating a touch panel as an input device on the light guide, comprising the steps of selecting whether a film base is laminated or a conductive electrode film is coated on a surface of the light guide on the basis of lower elements of the touch panel; pre-processing the touch panel and the light guide in such a manner that the light guide becomes one of the lower elements of the touch panel by laminating or coating the film base or the conductive electrode film on the light guide in accordance with the film base or the conductive electrode film selected in the above step; post-processing the touch panel and the light guide in such a manner that after completion of the lower elements of the touch panel by incorporating the light guide into the lower elements of the touch panel through the pre-processing step, the other film bases or conductive electrode films corresponding to upper elements are laminated on the light guide; and laminating the light guide of the touch panel with the light guide integrally formed therein through the pre- and post-processing steps onto the upper glass sheet.

Further objects and advantages of this invention will be apparent from the following detailed description of the presently preferred embodiments which are illustrated schematically in the accompanying drawings.

### BRIEF DESCRIPTION OF THE DRAWINGS

FIG. 1 is a schematic view illustrating the structure of a general frontlight LCD.

FIG. 2 is a schematically sectional view illustrating the laminating structure of the frontlight LCD of FIG. 1 to which a touch panel is added as an input device.

FIG. 3 is a schematic view illustrating a resistive touch panel applied to the input device of the general frontlight LCD.

FIG. 4 shows a light reflective path about a light axis in the conventional frontlight LCD to which the touch panel is added as the input device.

FIG. 5 shows the structure of a touch panel integrally formed with a light guide according to the present invention applied to an input device of a frontlight LCD.

FIG. 6 shows a light reflective path where the touch panel integrally formed with the light guide according to the present invention applied to the input device of the frontlight LCD.

FIG. 7 is a schematic view illustrating the laminating structure of a resistive touch panel integrally formed with the light guide according to the present invention.

FIG. 8 is a schematic view illustrating the laminating structure of another resistive touch panel integrally formed with a light guide according to the present invention.

FIG. 9 is a schematic view illustrating the laminating structure of a capacitive touch panel integrally formed with a light guide according to the present invention.

FIG. 10 is a schematic view illustrating the laminating structure of another capacitive touch panel integrally formed with a light guide according to the present invention.

FIG. 11 a schematic view illustrating the laminating structure of a supersonic touch panel integrally formed with a light guide according to the present invention.

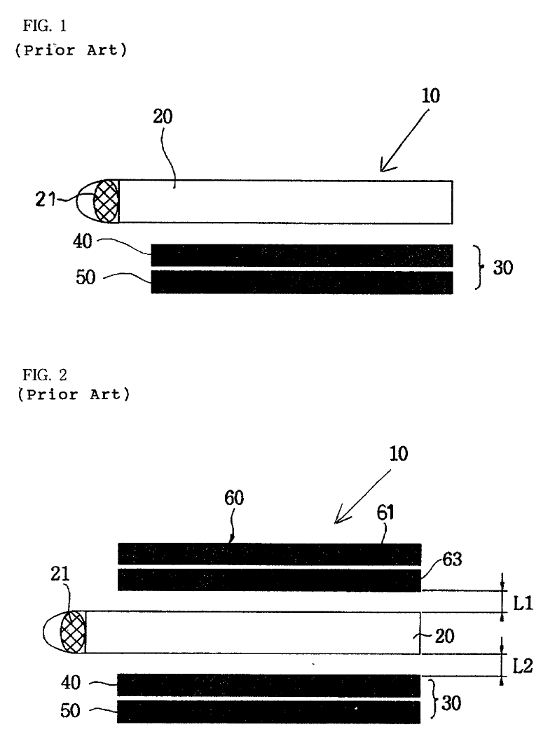

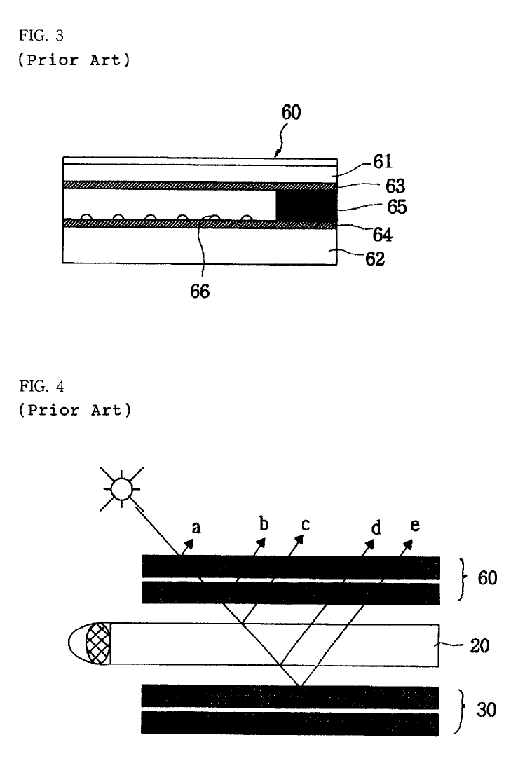

### DETAILED DESCRIPTION OF THE INVENTION

Before explaining the disclosed embodiments of the present invention in detail it is to be understood that the invention is not limited in its application to the details of the particular arrangement shown since the invention is capable of other embodiments. Also, the terminology used herein is for the purpose of description and not of limitation.

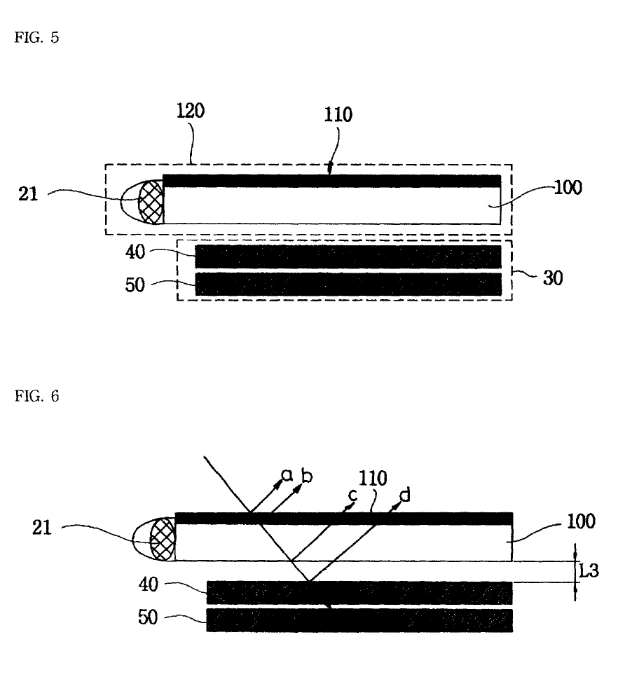

FIG. 5 shows schematically a structure of a touch panel with a light guide integrally formed therein according to the present invention which can be applied to a case where the touch panel as an input device is to be incorporated into or added to a frontlight LCD. FIG. 6 shows a light reflecting path in the touch panel with the light guide integrally formed therein according to the present invention which has been applied to the frontlight LCD.

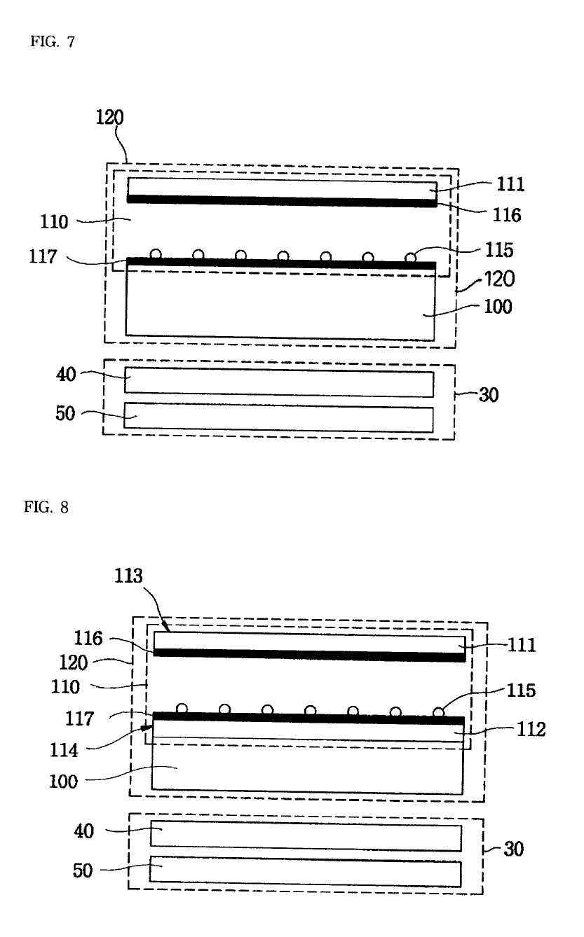

The touch panel with the light guide according to the present invention is configured such that the light guide is integrated with the touch panel by including the light guide as a lower component of the touch panel. FIGS. 7 to 11 show various models of touch panels with the light guides integrally formed therein.

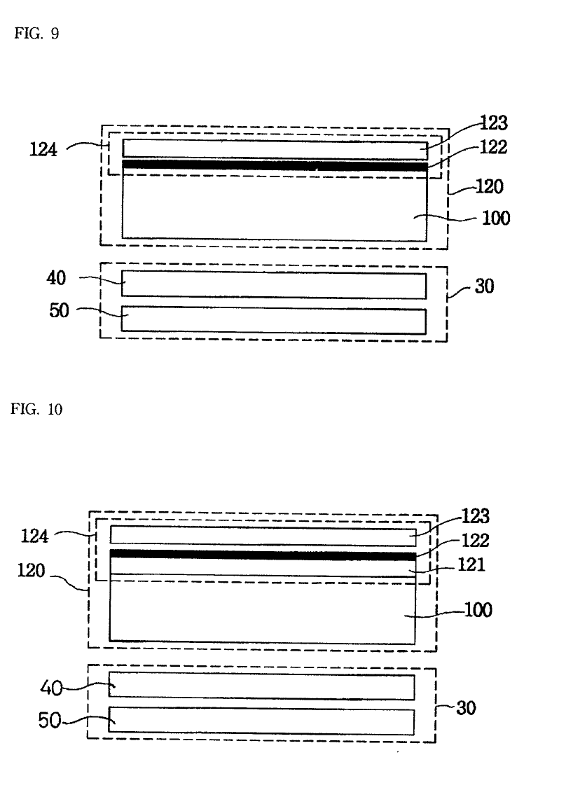

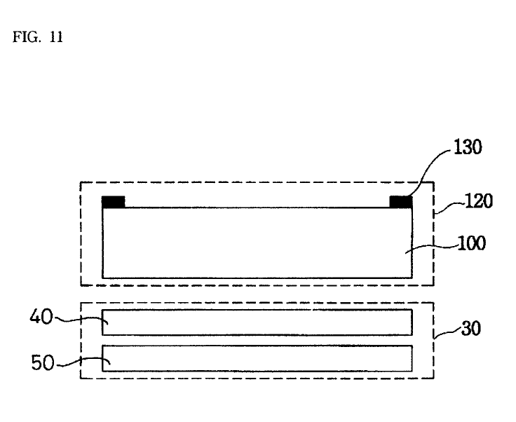

FIGS. 7 and 8 are directed to integration of the light guide in case of a resistive touch panel. FIGS. 9 and 10 are directed to integration of the light guide in case of a capacitive touch panel. FIG. 11 is directed to integration of the light guide in case of a ultrasonic wave touch panel.

The resistive touch panel basically includes an upper substrate having an upper sheet and a conductive electrode film formed beneath the upper sheet; a lower substrate having the same conductive electrode film as the upper substrate and a lower sheet formed beneath the conductive electrode film; spacers disposed between the upper and lower substrates; and electrodes for applying voltage to the resistive films between the upper and lower sheets. The capacitive touch panel has a conductive electrode film and a protective film but no spacers. The ultrasonic wave touch panel has a reflector.

FIG. 7 shows a resistive touch panel with a light guide integrally formed therein 120 according to the present invention, which can be laminated on a frontlight LCD 30 so as to serve as an input device. In this case, it is configured by sequentially laminating the frontlight LCD 30, a light guide 100, and a resistive touch panel 110, wherein the frontlight LCD 30 includes an upper glass sheet 40, liquid crystals, and a lower glass sheet 50, the light guide 100 is bonded to the upper glass sheet 40 of the frontlight LCD 30 and has a frontlight lamp 21, and the resistive touch panel 110 includes an upper sheet 111, and spacers 115 and conductive electrode films 116, 117 between the upper sheet 111 and the light guide 100 in this order with respect to the light guide 100.

The essential portion is a structure with the light guide 100 integrally formed in the touch panel 110, which is constructed in such a manner that the light guide 100 is laminated on the bottom of the conductive electrode film 117 of the touch panel 110, which is coated on a surface of the light guide 100, that the spacers 115 are placed on the conductive electrode film 117 coated on the light guide 1 00, and that the upper sheet 111 is bonded to the light guide so that the conductive electrode film 116 of the upper sheet 111 faces the spacers 115 and the conductive electrode film 117.

In a case where such structure is laminated on the frontlight LCD 30 as shown in FIG. 6, since an air gap exists only at one position of L3 and the surface reflecting paths a, b are eliminated, there are only the reflecting paths c, d of the air gap L3, whereby the light transmissivity is enhanced over the prior art. In addition, since the conductive electrode film 117 is coated directly on the light guide 110 without the lower sheet 112, its thickness and weight are reduced as a whole.

FIG. 8 shows another resistive touch panel with the light guide integrally formed therein 120 according to the present invention, which can be laminated on a frontlight LCD so as to serve as the input device. In this case, it is configured by sequentially laminating the frontlight LCD 30, the light guide 100, and the resistive touch panel 110, wherein the frontlight LCD 30 includes the upper glass sheet 40, the liquid crystals, and the lower glass sheet 50, the light guide 100 is bonded to the upper glass sheet 40 of the frontlight LCD 30 and has the frontlight lamp 21, and the touch panel 110 includes upper and lower sheets 111, 112, and the spacers 115 and the conductive electrode films 116, 117 between the upper and lower sheets 111, 112 in this order with respect to the light guide 100.

The essential portion is a structure with the light guide 100 integrally formed in the touch panel 110, which is constructed in such a manner that the light guide 100 is laminated on and bonded to the bottom of the lower sheet 112 of the touch panel 110, that a lower substrate 114 is formed by coating the conductive electrode film 117 on the lower sheet 112 and then placing the spacers 115 on the conductive electrode film 117, and that an upper substrate 113 including the conductive electrode film 116 and the upper sheet 111 is bonded on the spacers 115 of the lower substrate 114 so that the upper and lower conductive electrode films 116, 117 face each other.

In a case where such structure is laminated on the frontlight LCD 30 as shown in FIG. 6, since the air gap exists only at one position of L3 and the surface reflecting paths a, b are eliminated, there are only the reflecting paths c, d of the air gap L3, whereby the light transmissivity is enhanced over the prior art.

FIG. 9 shows a capacitive touch panel with the light guide integrally formed therein 120 according to the present invention, which can be laminated on a frontlight LCD so as to serve as the input device. In this case, it is configured by sequentially laminating the frontlight LCD 30, the light guide 100, and a capacitive touch panel 124, wherein the frontlight LCD 30 includes the upper glass sheet 40, the liquid crystals, and the lower glass sheet 50, the light guide 100 is bonded to the upper glass sheet 40 of the frontlight LCD 30 and has the frontlight lamp 21, and the capacitive touch panel 124 includes a conductive electrode film 122, and a protecting film 123 for protecting the conductive electrode film 122 in this order with respect to the light guide 100.

The essential portion is a structure with the light guide integrally formed in the touch panel, which is constructed in such a manner that the conductive electrode film 122 of the capacitive touch panel 124 is coated and formed directly on the surface of the light guide 100, and that the protecting film 123 is laminated on the conductive electrode film 122.

In a case where such structure is laminated on the frontlight LCD 30 as shown in FIG. 6, since the air gap exists only at one position of L3 and the surface reflecting paths a, b are eliminated, there are only the reflecting paths c, d of the air gap L3, whereby the light transmissivity is enhanced over the prior art. In addition, since the conductive electrode film 122 is coated directly on the light guide 110 without film base of a lower sheet, its thickness and weight are reduced in view of the entire module.

FIG. 10 shows another capacitive touch panel with the light guide integrally formed therein 120 according to the present invention, which can be laminated on a frontlight LCD so as to serve as the input device. In this case, it is configured by sequentially laminating the frontlight LCD 30, the light guide 100, and the capacitive touch panel 124, wherein the frontlight LCD 30 includes the upper glass sheet 40, the liquid crystals, and the lower glass sheet 50, the light guide 100 is bonded to the upper glass sheet 40 of the frontlight LCD 30 and has the frontlight lamp 21, and the capacitive touch panel 124 includes a lower sheet 121, the conductive electrode film 122, and the protecting film 123 for protecting the conductive electrode film 122 in this order with respect to the light guide 100.

The essential portion is a structure with the light guide 100 integrally formed in the touch panel 124, which is constructed in such a manner that the lower sheet 121 of the capacitive touch panel 124 is laminated on the surface of the light guide 100 so that the light guide 100 is integrated with the lower sheet 121 of the touch panel 124, and that the conductive electrode film 122 and the protecting film 123 are sequentially laminated on the lower sheet 121.

In a case where such structure is laminated on the frontlight LCD 30 as shown in FIG. 6, since the air gap exists only at one position of L3 and the surface reflecting paths a, b are eliminated, there are only the reflecting paths c, d of the air gap L3, whereby the light transmissivity is enhanced over the prior art.

FIG. 11 shows an ultrasonic wave touch panel with the light guide integrally formed therein 120 according to the present invention, which can be laminated on a frontlight LCD so as to serve as the input device. This structure is a case where a reflector 130 corresponding to a component of the ultrasonic wave touch panel is integrated with the surface of the light guide 100. This can also be considered as a case whether the light guide is integrally formed in the touch panel. Similarly, if a touch function of the touch panel is formed on the bottom of the light guide 100, the same general functions and benefits as the touch panel with the light guide integrally formed therein can be obtained. For example, in a case where such structure is laminated on the frontlight LCD 30 as shown in FIG. 6, since the air gap exists only at one position of L3 and the surface reflecting paths a, b are eliminated, there are only the reflecting paths c, d of the air gap L3, whereby the light transmissivity is enhanced, its thickness is thinned, and its weight is reduced.

The laminating operation of the touch panel with the light guide integrally formed therein according to the present invention and of addition of it as the input device to the frontlight LCD will be described as follows.

A method for laminating a touch panel with a light guide integrally formed therein by laminating the light guide on an upper glass sheet of a frontlight LCD and then laminating a touch panel as an input device on the light guide, comprises the steps of selecting whether a film base is laminated or a conductive electrode film is coated on a surface of the light guide on the basis of lower elements of the touch panel; pre-processing the touch panel and the light guide in such a manner that the light guide becomes one of the lower elements of the touch panel by laminating or coating the film base or the conductive electrode film on the light guide in accordance with the film base or the conductive electrode film selected in the above step; post-processing the touch panel and the light guide in such a manner that after completion of the lower elements of the touch panel by incorporating the light guide into the lower elements of the touch panel through the pre-processing step, the other film bases or conductive electrode films corresponding to upper elements are laminated on the light guide; and laminating the light guide of the touch panel with the light guide integrally formed therein through the pre- and post-processing steps onto the upper glass sheet.

In a case where the touch panel is the resistive type, during the pre-processing step, the spacers are arranged along the conductive electrode film coated directly on the light guide or on the film base.

Similarly, the touch panel with the light guide integrally formed therein is completely laminated by the selection of the film base or the conductive electrode film, the pre-processing step, and the post-processing step, so that it can be made as a unit product for the frontlight LCD.

Since at least an air gap between the touch panel and the light guide can be eliminated when the touch panel or the touch panel with the light guide integrally formed therein is laminated on the LCD, a flat panel display of high image quality can be realized through the improvement of the light transmissivity. In addition, since the light guide is first integrated with the touch panel and the light guide is then laminated on the upper glass sheet upon manufacture thereof, the process of mounting the touch panel on the frontlight LCD is easily performed and a high yield is obtained.

According to the present invention, in case of the frontlight LCD to which the light guide is applied, when the touch panel with the light guide integrally formed therein, or the light guide with the touch panel integrally formed therein is laminated on the frontlight LCD, since the touch panel includes the light guide as a lower component of the touch panel beforehand, the application of the touch panel as the input device to the frontlight LCD has advantages of lightness, miniaturization and thinness in view of its structure. Further, the formation of the air gap at a laminated portion is previously prevented in the touch panel with the light guide integrally formed therein, or the light guide with the touch panel integrally formed therein, so that the loss of light transmissivity is reduced and thus image quality is improved and the problem of operability is simultaneously solved. Moreover, the process of manufacturing the touch panel with the light guide integrally formed therein, which can be used for the input device of the frontlight LCD with the light guide applied thereto, can be applied to the resistive touch panel as well as other touch panels. There is a further advantage in that a high yield and mass production of products having high reliability can be achieved since the workability is improved in the process.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A touch panel with a light guide integrally formed therein, which is configured by sequentially laminating a frontlight LCD having an upper glass sheet, liquid crystals and a lower glass sheet; a light guide bonded to said upper glass sheet of said frontlight LCD and having a frontlight lamp; and a touch panel having an upper sheet, spacers and conductive electrode films between said upper sheet and said light guide in this order with respect to said light guide, wherein:
one of said conductive electrode films of said touch panel is coated on a surface of said light guide; and
said spacers are placed on said one of said conductive electrode films coated on said light guide, and said upper sheet is bonded to said light guide so that the other of said conductive electrode films of said touch panel faces said spacers and said one of said conductive electrode films.

2. A touch panel with a light guide integrally formed therein, which is configured by sequentially laminating a frontlight LCD having an upper glass sheet, liquid crystals and a lower glass sheet; a light guide bonded to said upper glass sheet of said frontlight LCD and having a frontlight lamp; and a touch panel having an upper sheet, a lower sheet, spacers and conductive electrode films between said upper sheet and said lower sheet in this order with respect to said light guide, wherein:
said light guide is laminated on and bonded to the bottom of said lower sheet of said touch panel; and
a lower substrate is formed by coating one of said conductive electrode films on said lower sheet and then placing said spacers on said conductive electrode film, and an upper substrate having the other of said conductive electrode films and said upper sheet is bonded on said spacers of said lower substrate so that said upper and lower conductive electrode films face each other.

3. A touch panel with a light guide integrally formed therein, which is configured by sequentially laminating a frontlight LCD having an upper glass sheet, liquid crystals and a lower glass sheet; a light guide bonded to said upper glass sheet of said frontlight LCD and having a frontlight lamp; and a capacitive touch panel having a conductive electrode film and a protecting film for protecting said conductive electrode film in this order with respect to said light guide, wherein:
said conductive electrode film of said capacitive touch panel is coated and formed directly on a surface of said light guide; and
said protective film is laminated on said conductive electrode film.

4. The touch panel with the light guide integrally formed therein as claimed in claim 3, wherein since said lower sheet of said capacitive touch panel is laminated on said surface of said light guide so that said light guide is integrated with said lower sheet of said touch panel, and said conductive electrode film and said protective film are sequentially laminated on said lower sheet.

5. A method for laminating a touch panel with a light guide integrally formed therein, comprising the steps of:
selecting whether at least one of: a film base is laminated and a conductive electrode film is coated, on a surface of said light guide on basis of lower elements of said touch panel;
pre-processing said touch panel and said light guide such that said light guide becomes one of said lower elements of said touch panel by at least one of: laminating said film base, coating said film base, laminating said conductive electrode film, and coating said conductive electrode film, on said light guide in accordance with at least one of: said film base and said conductive electrode film, selected in the above step; and
post-processing said touch panel and said light guide such that after completion of said lower elements of said touch panel by incorporating said light guide into said lower elements of said touch panel through said pre-processing step, at least one of: other film bases and the conductive electrode films, corresponding to upper elements are laminated on said light guide.

6. The method for laminating the touch panel with the light guide integrally formed therein as claimed in claim 5, wherein when said touch panel is a resistive touch panel, said pre-processing step comprises arranging spacers along said conductive electrode film coated directly on at least one of: said light guide, and on said film base.

7. A method for laminating a touch panel with a light guide integrally formed therein by laminating said light guide on an upper glass sheet of a frontlight LCD and then laminating a touch panel as an input device on said light guide, comprising the steps of:
selecting whether at least one of: a film base is laminated and a conductive electrode film is coated, on a surface of said light guide on basis of lower elements of said touch panel;
pre-processing said touch panel and said light guide such that said light guide becomes one of said lower elements of said touch panel by at least on of: laminating said film base, coating said film base, laminating said conductive electrode film, and coating said electrode film, on said light guide in accordance with at least one of said film base and said conductive electrode film selected in the above step;
post-processing said touch panel and said light guide in such that after completion of said lower elements of said touch panel by incorporating said light guide into said lower elements of said touch panel through said pre-processing step, at least one of the other film bases and the conductive electrode films, corresponding to upper elements are laminated on said light guide; and
laminating said light guide of said touch panel with said light guide integrally formed therein through said pre- and post-processing steps onto said upper glass sheet.
